(19) United States
(12) Patent Application Publication
(10) Pub. No.: US 2026/0186748 A1
(43) Pub. Date: Jul. 2, 2026

(54) MANAGING RULES IN ENTERPRISE APPLICATIONS DEVELOPED BY CODELESS PLATFORM

(71) Applicant: NB Ventures, Inc. DBA GEP, Clark, NJ (US)

(72) Inventors: Subhash Makhija, Westfield, NJ (US); Nithin Maruthi Prasad, Avenel, NJ (US); Shivendra Singh Malik, Vasco-da-Gama (IN)

(21) Appl. No.: 19/005,046

(22) Filed: Dec. 30, 2024

(51) Int. Cl. G06F 8/30; G06F 40/30

(52) U.S. Cl. CPC G06F 8/30; G06F 40/30

(57) ABSTRACT

The present invention provides a data processing system and method for managing rules in one or more enterprise applications developed by codeless platform. The invention includes large language model (LLM) based intent detection for rule identification, creations, updating or deletion. Further, the invention determines conflicts in execution of rules by identifying the impact of execution of the rule on one or more functions of the application.

### BACKGROUND

### 1. Technical Field

This disclosure relates generally to data processing in enterprise applications developed by codeless platform. More particularly, the invention relates to Artificial intelligence (AI) agents and large language models (LLM) based data processing for managing rule in one or more enterprise application including procurement and supply chain applications developed by codeless platform.

### 2. Description of the Prior Art

Various important functions in organizations are controlled by Enterprise applications (EA) and supply chain management (SCM) applications. To manage different requirements, the applications include various servers, databases, and computer-based systems. These requirements may be in diverse areas such as finance, sales, logistics, asset, purchasing, and inventory, among others.

Depending on the requirement, the processes in the applications are transformed. However, traditional systems are typically dedicated for performing limited functions as structured by the system or service provider with limited operational behaviors and features. Major features and behavior changes to traditional systems require significant development efforts. Systems that are created to be flexible require extensive custom development work to meet custom requirements.

Further, over the years there has been a shift from client-server systems to SAAS or cloud-based systems that are deployed to meet the operational requirements of an organization. While the client-Server systems typically provide more feature rich interface and wider range of compatible hardware, the SAAS based system is difficult to implement dynamic changes due to un-stretchable nature of the architecture of the SAAS platform. Moreover, for EA and SCM applications the operational behavior and dynamic extension of functional processes makes it even more difficult to configure systems implemented on cloud-based environment.

Transformation in operation processes in enterprises directly impacts the enterprise applications. The applications need to adopt such transformational changes at all levels. However, the current applications are rigid and inflexible to such changes. The capability to support the dynamic changes driven by operational requirements is lagging and organizations need extensive amount of time to make changes to meet the requirements. Moreover, this impacts the overall efficiency and increases various technical challenges in carrying out the modifications without impacting the associated functions of the applications that may not require modification.

Every function in an ERP or SCM system requires a specific process or rule to carry out the task. The type and characteristic of data utilized for carrying out these functions is different for different tasks. Due to inherent structural and architectural limitations, the existing systems are unable to pre-empt all issues arising out of an ERP or SCM system and devise a solution. Further, User interface (UI) of the current ERP and SCM applications are not equipped to handle dynamic changes in the functions, parameters considered to carry out the functions and data flowing through the application.

The ERP or supply chain applications are driven by rules for executing the required functions. Moreover, when one enterprise application interacts with another application structured differently, the compatibility for exchanging information is extremely complex and makes it technically challenging to allocate resources, test capability of the existing resources and determine the technical modifications required at the architectural level to carry out the desired integration task. Since the rules are created by a developer, the probability of one change impacting another function increases. The existing systems are error prone as there are unforeseen aspects of modification to an application that are not known to the developer.

Accordingly, there is a need in the art for improved supply chain management (SCM) and ERP system applications that are dynamically configurable by an organization as per their needs without requiring a service provide to carry out changes to meet the requirement. More so, in an environment where the rules that structure the application or integrate one application to another require determination of unknown technical factors that may impact the functions and working of the application itself.

### SUMMARY OF THE INVENTION

Accordingly, the present invention provides a data processing method and system for managing rules in one or more enterprise applications developed by codeless platform. The method includes receiving an input on graphical user interface (GUI) of a conversational assistant from a user at a server for executing at least one task, triggering an intent identification Artificial intelligence (AI) agent for identifying an intent of the user from the received input, transforming the identified intent into actionable data script for executing the at least one task associated with the identified intent wherein a bot is configured for transferring the intent to a Large language model (LLM) for generating the actionable script; and generating by the LLM, a data structure required for a rules API to execute the at least one task thereby managing rules in the enterprise application.

In an embodiment, the data processing method of managing rules with transforming intent into actionable script includes mapping one or more data attributes of the identified intent with one or more application functions associated with the data attributes, wherein a linkedchain is configured to connect the data attributes to one or more linkedchain nodes of the one or more application functions through a linkedchain control module. The method also includes determining one or more data objects indicating impact of the intent on the one or more application functions; and generating by an action bot, one or more optimization protocols for transforming the intent into actionable script, wherein the linkedchain control module is configured to enable recalibration of one or more application functions based on the optimization protocols for ensuring execution of the intent.

In a related embodiment, the applications include a supply chain management application and the at least one task includes a rule management task including rule creation, rule modification or rule deletion task associated with a supply chain management application task such as contract management, Purchase order, invoice management, Spend analysis, Sourcing, inventory management, demand planning, quality management, supply planning, should cost modeling, transportation management, warehouse management, forecasting, vendor management, risk assessment management and project management.

In an embodiment, in response to identification of the intent and determination of the task as a rule migration task, the method of managing rules include triggering the LLM configured for mapping data schema of a first enterprise application with requirements of a second enterprise application, wherein the bot is configured for auto creating and ingesting data of the first enterprise application onto the second enterprise application by the linkedchain control module.

In an embodiment, wherein the linked-chain nodes connect to the one or more application functions through configurable components of the enterprise application wherein an AI engine correlates the data attributes with the one or more linked-chain nodes for generating the actionable data script created by utilizing a library of functions stored on a functional database.

In an embodiment, the method of managing rules include processing the historical data to predict the impact of the input on the one or more application functions and generating an actionable script for execution of the at least one task based on a dynamic processing logic.

In an embodiment, the at least one task includes creating rule for embedding templates to restructure the application wherein the templates are related to sourcing, procurement or supply chain functions.

In another embodiment, the at least one task includes modification of an existing rule to alter UI component on the application for accommodating transformations required based on new operational requirement for the application.

In yet another embodiment, the at least one task includes injecting rules for configuring labels in multi languages of form elements and publish the labels on the application to start leveraging operational forms including Purchase Order, Contract and Inventory.

In an embodiment, a code of the one or more protocols configured for transforming the intent into actionable script enables identification of the linkedchain node associated with the one or more application functions.

In an embodiment, the codeless platform is configured to enable at least one processor for codeless application development. The codeless platform includes a customization layer; an application layer; a shared framework layer; a foundation layer; a data layer; and an application orchestrator wherein the one or more processors is configured to cause the plurality of configurable components to interact with each other in a layered architecture to customize the one or more application based on at least one operation to be executed using the customization layer, organize at least one application service of the one or more application by causing the application layer to interact with the customization layer through one or more configurable components of the plurality of configurable components, wherein the application layer is configured to organize the at least one application service of the one or more application. The one or more processors are configured to cause the configurable components to interact with each other to fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components, manage database native queries mapped to that at least one operation using a data layer to communicate with the foundation layer through one or more configurable components of the plurality of configurable components, wherein the data layer is configured to manage database native queries mapped to the at least one operation; and execute the at least one operation and develop the one or more application using the application orchestrator to enable interaction of the plurality of configurable components in the layered architecture.

In an advantageous aspect, the present invention provides cross application connectivity that reduces the number of rules across multiple applications. This further helps in maintenance of the rules and also in conflict resolution in a single rule. Moreover, the AI system enables creation of a rule through generation of a trained model which increases the quality of rule creation and prevents errors like in existing developer-based rule creation systems.

In another advantageous aspect, the invention provides LLM based rule management system to understand the user input for intent identification, feeding it to a machine learning algorithm that can convert this conversational input to system understandable language and then augment machine learning based rule service to create the rule in the database.

In yet another advantageous aspect, the system, associated components/elements of the system and method of the present invention reduce effort and enhance efficiency by providing a set of configurable tools, services and components that are restructured through AI processing logic for compatibility with respect to any ERP or SCM operation. Since, any web application development involves considerable rule creation or modification effort, the structure of the present system enables boilerplate of a seed that follow the best practices and enforce standards as it is a vital process to cut cost and boost productivity. Further, the invention provides enterprise seed structure, core, shared and features modules, centralized metadata, configurations, settings, data models and logging management. The invention maintains and tracks application state depending on the real time rule modifications and produces a series of changes applied to configuration and data. Also, the system employs unified generic UI components gallery to drastically reduce rule management tasks using AI processing logic.

The invention provides a system that is not dependent on a single set of machine learning or AI algorithms or protocols or certain data sets. These algorithms or data sets or protocols change, evolve over time and the system is configured to use these algorithms and data sets and thus continue to improve its rule management capability.

### BRIEF DESCRIPTION OF THE DRAWINGS

The disclosure will be better understood and when consideration is given to the drawings and the detailed description which follows. Such description makes reference to the annexed drawings wherein:

FIG. 1 is a view of a system for managing rules in an enterprise or supply chain management application developed by a codeless platform in accordance with an embodiment of the invention.

FIG. 1A is a sub architecture of a system with configurable components enabling linkedchain node implementation in enterprise application developed by codeless platform in accordance with an example embodiment of the invention.

FIG. 1B is a linkedchain based application architecture for managing one or more rule management operations of one or more enterprise applications in accordance with an embodiment of the invention.

FIG. 2 is an LLM based rule management architecture with RAG and CRAG in accordance with an embodiment of the invention.

FIG. 2A is an architecture diagram of the LLM based rule management architecture with integration framework, AI agent data library and one or more enterprise applications in accordance with an embodiment of the invention.

FIG. 3 is a flowchart depicting a method of managing rules in an enterprise application developed by codeless platform in accordance with an embodiment of the invention.

FIG. 3A is a flowchart depicting rule intent identification for management of rule in an enterprise application developed by codeless platform in accordance with an example embodiment of the invention.

FIG. 4 is a block diagram of domain model AI agent for data processing in accordance with an embodiment of the invention.

FIG. 5 a block diagram 500 depicting the guiding principle of the LLM based rule management architecture is provided in accordance with an embodiment of the invention.

FIG. 5A shows a design time AI agent integration architecture in accordance with an example embodiment of the invention.

FIG. 6 shows a flow diagram depicting a deep learning-based rule management architecture with encoder and decoder in accordance with an example embodiment of the invention.

FIG. 7 is a block diagram depicting an intent platform in accordance with an example embodiment of the invention.

FIG. 8 shows a conversational flow of a duplicate rule analyzer AI agent of the data processing system to the user input in accordance with an embodiment of the invention.

### DETAILED DESCRIPTION

Described herein are nonlimiting example embodiments of the present invention, which includes Artificial Intelligence, machine learning based enterprise and supply chain management systems and methods for managing rules in one or more enterprise applications.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,”“connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “protocols,” “rules,” or “scripts,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures.

The subject matter of various embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to system and method for managing rules in enterprise and supply chain management applications developed by a codeless platform.

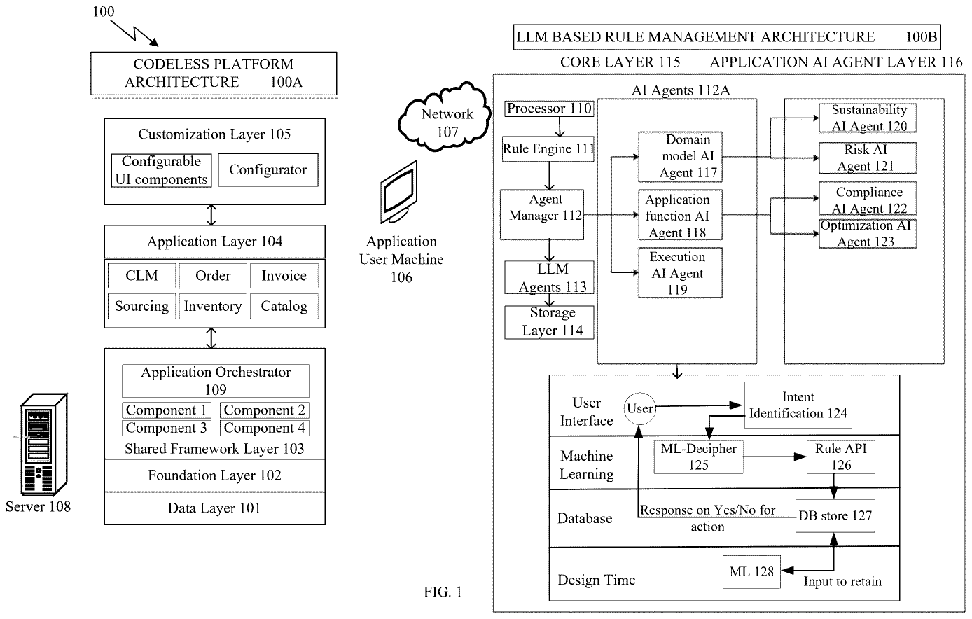

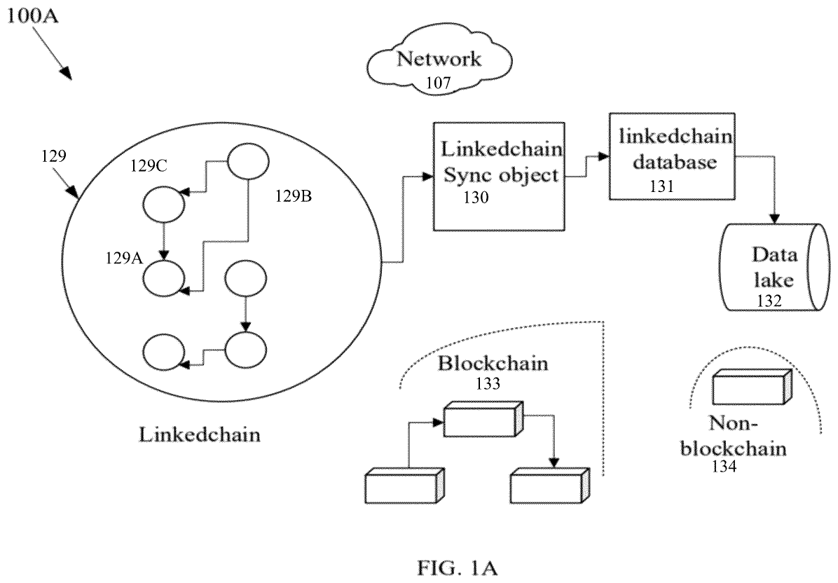

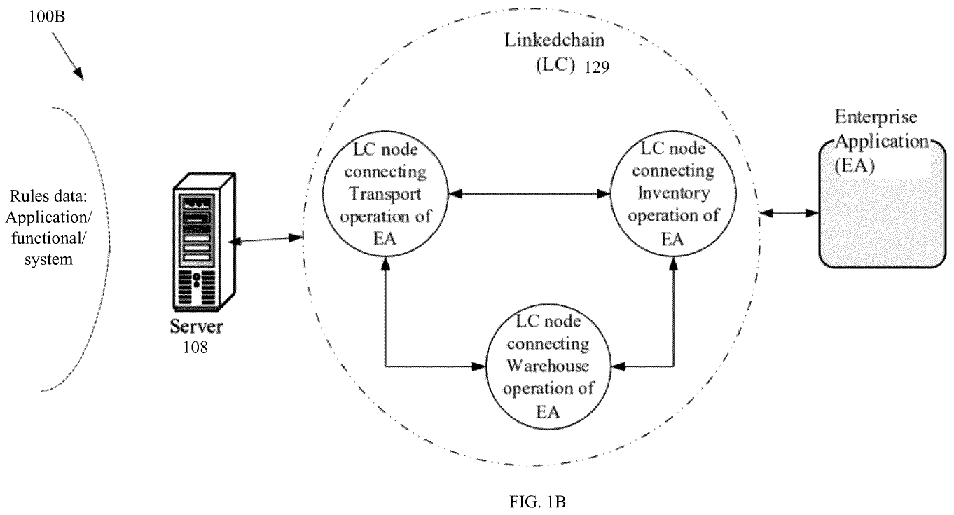

Referring to FIG. 1, an architecture diagram of a LLM based data processing system 100 for managing rules in an enterprise application developed by a codeless platform is provided in accordance with an embodiment of the present invention. The architecture of the system includes a codeless platform architecture 100A and a LLM based rule management architecture 100B.

The codeless platform architecture 100A of the system 100 is a layered architecture 100A configured to process complex operations of one or more applications including supply chain management (SCM) applications using configurable components of each layer of the architecture 100A. The layered architecture enables faster processing of complex operations as the workflow may be reorganized dynamically using the configurable components. The layered architecture includes a data layer 101, a foundation layer 102, a shared framework layer 103, an application layer 104 and a customization layer 105. Each layer of the codeless platform architecture 100A includes a plurality of configurable components interacting with each other to execute at least one operation of the SCM enterprise application. It shall be apparent to a person skilled in the art that while FIG. 1 provide essential configurable components, the nature of the components itself enables redesigning of the platform architecture through addition, deletion, modification of the configurable components and their positioning in the layered architecture. Such addition, modification of configurable components depending on the nature of the architecture layer function shall be within the scope of this invention.

In an exemplary embodiment, the configurable components enable an application developer user/citizen developer, a platform developer user and a SCM application user working with the SCM application to execute the operations to code the elements of the SCM application through configurable components. The SCM application user or end user triggers and interacts with the customization layer 105 for execution of the operation through application user machine 106, a function developer user or citizen developer user triggers and interacts with the application layer 104 to develop the SCM application for execution of the operation through citizen developer machine, and a platform developer user through its computing device triggers the shared framework layer 103, the foundation layer 102 and the data layer 101 to structure the platform for enabling codeless development of SCM applications.

In an embodiment the present invention provides one or more SCM enterprise application with an end user application UI and a citizen developer user application UI for structuring the interface to carry out the required operations. Further, the layered platform architecture reduces complexity as the layers are built one upon another thereby providing high levels of abstraction, making it extremely easy to build complex features for the SCM application. However, one or more applications developed through the platform architecture requires reconfiguration of task management in the application. Since the functions are added or removed or modified by the developer seamlessly, the modification of the rules in the system to manage the related changes in the task is cumbersome.

In one embodiment, the codeless platform architecture 100A provides the cloud agnostic data layer 101 as a bottom layer of the architecture. This layer provides a set of micro-services that collectively enable discovery, lookup and matching of storage capabilities to needs for execution of operational requirement. The layer enables routing of rule modification or creation requests to the appropriate storage adaptation, translation of any requests to a format understandable to the underlying storage engine (relational, key-value, document, graph, etc.). Further, the layer manages connection pooling and communication with the underlying storage provider and automatically scales and de-scales the underlying storage infrastructure to support operational growth demands.

In an example embodiment, a document data stores data abstraction of the data layer store all attributes of a document as a single record, much like a relational database system. The data is usually denormalized in these document stores, making data joins common in traditional relational systems unnecessary. Data joins (or even complex queries) can be expensive with this data store, as they typically require map/reduce operations which don't lend themselves well in transactional systems (OLTP-online transactional processing).

In another example embodiment, a relational data abstraction of the data layer allows for data to be sliced and analyzed in an extremely flexible manner.

In a related embodiment, the plurality of configurable components includes one or more data layer configurable components including but not limited to Query builder, graph database parser, data service connector, transaction handler, document structure parser, event store parser and tenant access manager. The data layer provides abstracted layers to the SCM service to perform data operations like Query, insert, update, delete and Join on various types of data stores document database (DB) structure, relational structure, key value structure and hierarchical structure.

In an embodiment the platform architecture provides 100A the foundation layer 102 on top of the data layer 101 of the architecture 100A. This layer provides a set of microservices that execute the tasks of managing code deployment, supporting code versioning, deployment (gradual roll out of new code) etc. The layer collectively enables creation and management of smart forms (and templates), framework to define UI screens, controls etc. through use of templates. Seamless theming support is built to enable specific form instances (created at runtime) to have personalized themes, extensive customization of the user experience (UX) for each client entity and or document. The layer enables creation, storage and management of code plug-ins (along with versioning support). The layer includes microservice and libraries that enable traffic management of transactional document data (by client entity, by document, by template, etc.) to the data layer 101, enables logging and deep call-trace instrumentation, support for request throttling, circuit breaker retry support and similar functions. Another set of microservice enables service to service API authentication support, so API calls are always secured. The foundation layer micro services enable provisioning (on boarding new client entity and documents), deployment and scaling of necessary infrastructure to support multi-tenant use of the platform. The set of microservices of foundation layer are the only way any higher layer microservice can talk to the data layer microservices. Further, machine learning techniques auto-scale the platforms to optimize costs and recommend deployment options for entity such as switching to other cloud vendors etc.

In an exemplary embodiment, the data layer 101 and foundation layer 102 of the architecture 100 function independent of the knowledge of the operation. Since, the platform architecture builds certain configurable component as independent of the operation in the application, they are easily modifiable and restructured.

In a related embodiment, the plurality of configurable components includes one or more foundation layer configurable components including but not limited to logger, Exception Manager, Configurator Caching, Communication Layer, Event Broker, Infra configuration, Email Sender, SMS Notification, Push notification, Authentication component, Office document Manager, Image Processing Manager, PDF Processing Manager, UI Routing, UI Channel Service, UI Plugin injector, Timer Service, Event handler, and Compare service for managing infrastructure and libraries to connect with cloud computing service.

In an embodiment, the platform architecture provides the shared framework layer 103 on top of the foundation layer 102. This layer provides a set of microservices that collectively enable authentication (identity verification) and authorization (permissioning) services. The layer supports cross-document and common functions such as rule engine, workflow management, document approval (built likely on top of the workflow management service), queue management, notification management, one-to-many and many-to-one cross-document creation/management, etc. The layer enables creation and management of schemas (aka documents), and support orchestration services to provide distributed transaction management (across documents). The service orchestration understands different document types, hierarchy and chaining of the documents etc.

The shared framework layer 103 has the notion of our operational or application domains, the set of microservices that contribute this layer hosts all the common functionality so individual documents (implemented at the application layer 104) do not have to repeatedly to the same work. In addition to avoiding the reinventing the wheel separately by each developer team, this layer of microservices standardizes the capabilities so there is no loss of features at the document level, be it adding an attribute (that applies to a set of documents), supporting complex approval workflows, etc. The rule engine along with tools to manage rules is part of this layer.

In a related embodiment, the plurality of configurable components includes one or more shared framework configurable components including but not limited to license manager, Esign service, application marketplace service, Item Master Data Component, organization and accounting structure data component, master data, Import and Export component, Tree Component, Rule Engine, Workflow Engine, Expression Engine, Notification, Scheduler, Event Manager, and version service.

In one embodiment, the architecture 100A provides the application layer 104 on top of the shared framework layer 103 of the architecture. The developer user of the platform will interact with the application layer 103 for structuring the SCM application. This is also the first layer, that defines SCM specific documents such as requisitions, contracts, orders, invoices etc. This layer provides a set of microservices to support creation of documents (requisition, order, invoice, etc.), support the interaction of the documents with other documents (ex: invoice matching, budget amortization, etc.) and provide differentiated operational/functional value for the documents in comparison to a competition by using artificial intelligence and machine learning. This layer also enables execution of complex operational/functional use cases involving the documents.

In an exemplary embodiment, a developer user or admin user will structure one or more SCM application and associated functionality by the application layer of microservices, either by leveraging the shared frameworks platform layer or through code to enable the notion of specific documents or through building complex functionality by intermingling shared frameworks platform capabilities with custom code. Besides passing on the entity metadata to the shared frameworks layer, this set of microservices do not carry any concern about where or how data is stored. Data modeling is done through template definitions and API calls to the shared frameworks platform layer. This enables this layer to primarily and solely focus on adding operational/functional value without worrying about infrastructure.

Further, in an advantageous aspect, all functionality or application services built at the application layer are exposed through an object model, so higher levels of application orchestrations of all these functionalities is possible to build by custom implementations for end users. The platform will stay pristine and clean and be generic, while at the same time, enables truly custom features to be built in a lightweight and agile manner. The system of the invention is configured to adapt to the changes in the application due to the custom features and operate the application to manage one or more tasks to be executed.

In an embodiment, the architecture 100A provides the customization layer 105 as the topmost layer of the architecture above the application layer 104. This layer provides microservices enabling end users to write codes to customize the operational flows as well as the end user application UI to execute the operations of SCM. The end user can orchestrate the objects exposed by the application layer 104 to build custom functionality, to enable nuanced and complex workflows that are specific to the end user operational requirement or a third-party implementation user.

In a related embodiment, the plurality of configurable components includes one or more customization layer configurable components including but not limited to a plurality of rule engine components, configurable logic component, component for structuring SCM application UI, Layout Manager, Form Generator, Expression Builder Component, Field & Metadata Manager, store-manager, Internationalization Component, Theme Selector Component, Notification Component, Workflow Configurator, Custom Field Component & Manager, Dashboard Manager, Code Generator and Extender, Notification, Scheduler, form Template manager, State and Action configurator for structuring the one or more SCM application to execute at least one SCM application operation.

In an exemplary embodiment, each of these layers of the platform architecture communicates or interacts only to the layer directly below and never bypasses the layers through operational workflow thereby enabling highly productive execution with secured interaction through the architecture.

Depending on the type of user the user interface (UI) of the application user machine 106 is structured by the platform architecture. The application user machine 106 with an application user UI is configured for sending, receiving, modifying or triggering processes and data object for operating one or more of a SCM application over a network 107.

The computing devices referred to as the entity machine, server, processor etc. of the present invention are intended to represent various forms of digital computers, such as laptops, desktops, workstations, personal digital assistants, and other appropriate computers. Computing device of the present invention further intend to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this disclosure.

The system includes a server 108 configured to receive data and instructions from the application user machines 106. The system 100 includes a support mechanism for performing various prediction through AI engine and mitigation processes with multiple functions including historical dataset extraction, classification of historical datasets, artificial intelligence based processing of new datasets and structuring of data attributes for analysis of data, creation of one or more data models configured to process different parameters.

In an embodiment, the system is provided in a cloud or cloud-based computing environment. The codeless development system enables more secured processes.

In an embodiment the server 108 of the invention may include various sub-servers for communicating and processing data across the network. The sub-servers include but are not limited to content management server, application server, directory server, database server, mobile information server and real-time communication server.

In example embodiment the server 108 shall include electronic circuitry for enabling execution of various steps by server processor. The electronic circuity has various elements including but not limited to a plurality of arithmetic logic units (ALU) and floating-point Units (FPU's). The ALU enables processing of binary integers to assist in formation of at least one table of data attributes where the data models implemented for dataset characteristic prediction are applied to the data table for obtaining prediction data and recommending action for codeless development of SCM applications. In an example embodiment the server electronic circuitry includes at least one Athematic logic unit (ALU), floating point units (FPU), other processors, memory, storage devices, high-speed interfaces connected through buses for connecting to memory and high-speed expansion ports, and a low speed interface connecting to low speed bus and storage device. Each of the components of the electronic circuitry, are interconnected using various busses, and may be mounted on a common motherboard or in other manners as appropriate. The processor can process instructions for execution within the server 108, including instructions stored in the memory or on the storage devices to display graphical information for a graphical user interface (GUI) on an external input/output device, such as display coupled to high speed interface. In other implementations, multiple processors and/or multiple busses may be used, as appropriate, along with multiple memories and types of memory. Also, multiple servers may be connected, with each server providing portions of the necessary operations (e.g., as a server bank, a group of blade servers, or a multi-processor system).

In an example embodiment, the system of the present invention includes a front-end web server communicatively coupled to at least one database server, where the front-end web server is configured to process the rule data based on one or more data models and applying an AI based dynamic processing logic to automate execution of the task in the application developed by the codeless development actions.

In an embodiment, the platform architecture 100A of the invention includes an application orchestrator 109 configured for enabling interaction of the plurality of configurable components in the layered architecture 100 for executing at least one SCM application operation and development of the one or more SCM application. The application orchestrator 109 includes plurality of components including an application programming interface (API) for providing access to configuration and workflow operations of SCM application operations, an Orchestrator manager configured for Orchestration and control of SCM application operations, an orchestrator UI/cockpit for monitoring and providing visibility across transactions in SCM operations and an AI based application orchestration engine configured for interacting with a plurality of configurable components in the platform architecture for executing SCM operations.

In an embodiment, the application orchestrator 109 includes a blockchain connector for integrating blockchain services with the one or more SCM application and interaction with one or more configurable components. Further, Configurator User interface (UI) services are used to include third party networks managed by domain providers.

In a related aspect, the Artificial intelligence (AI) based orchestrator engine enables execution of SCM operation by at least one data model wherein the AI engine transfers processed data to the UI for visibility, exposes SCM operations through API and assist the manager for application orchestration and control.

In an exemplary embodiment, the AI engine employs machine learning techniques that learn patterns and generate insights from the rule data for enabling the process orchestrator to automate tasks. Further, the AI engine with ML employs deep learning that utilizes artificial neural networks to mimic biological neural network in human brains. The artificial neural networks analyze data to determine associations and provide meaning to unidentified or new rules.

In another embodiment, the invention enables integration of Application Programming Interfaces (APIs) for plugging aspects of artificial intelligence (AI) into the dataset characteristic prediction and operations execution for operating one or more SCM enterprise application.

In an embodiment, the system 100 of the present invention includes a workflow engine that enables monitoring of rules workflow across the SCM applications. The workflow engine with the application orchestrator 109 enables the platform architecture to create multiple application workflows based on the task to be executed.

In an embodiment the machine 106 may communicate with the server 108 wirelessly through communication interface, which may include digital signal processing circuitry. Also, the machine (106) may be implemented in a number of different forms, for example, as a smartphone, computer, personal digital assistant, or other similar devices.

In an embodiment, the rule management architecture 100B includes a processor 111 configured for receiving the input from a user through a conversational assistant on the electronic Graphical user interface (GUI) and generating a response. The processor 110 serves as the bridge between the user and the backend components of the rule management architecture. The rule management architecture 100B includes a core layer 115 and an application artificial intelligence (AI) agent layer 116. The architecture 100B further includes an AI based rule engine 111 coupled to the processor 110 and configured for processing received input on the interface, an AI agent manager 112, one or more LLM agents 113 and a storage layer 114. The AI agent manager 112 is configured to enable augmentation of LLM agents 113 through the processor 110. The Architecture 100B includes AI agents 112A including domain model (DM) AI agent 117, application function AI agent 118 and execution agent 119. The domain model (DM) AI agent 117 interacts with the sustainability AI agent 120 and risk AI agent 121 of the application AI agent layer. Also, the application function AI agent 118 interacts with the compliance AI agent 122 and the optimization AI agent 123. The architecture 100B includes AI tools including tools such as OCR, data and prediction at the core layer 115. The architecture 100B also includes an application data analyzer and an application function prediction at the application AI agent layer. The storage layer 114 is configured for storing one or more AI tools like multiple custom, curated and domain specific tools wherein each tool is built with a specific task or functionality to execute. The tools could be python functions, agents, API (application programming Interface) calls among others. The architecture 100B further includes user interface of a conversation assistant receiving input related to rule and performing intent identification 124 from the input. The machine learning block includes ML (Machine learning) decipher 125 and Rule API (application programming interface) 126. Further, the database (DB) includes DB store 127 for storing historical rule data. The design time of the architecture includes ML (machine learning) 128 interacting with the DB store 127 for retaining the input.

The processor 110 may be implemented as a chipset of chips that include separate and multiple analog and digital processors. The processor may provide coordination of the other components, such as controlling user interfaces, applications run by devices, and wireless communication by devices. The Processor may communicate with a user through control interface and display interface coupled to a display. The display may be, for example, a TFT LCD (Thin-Film-Transistor Liquid Crystal Display) or an OLED (Organic Light Emitting Diode) display, or other appropriate display technology. The display interface may comprise appropriate circuitry for driving the display to present graphical and other information to an entity/user. The control interface may receive commands from a user/demand planner and convert them for submission to the processor. In addition, an external interface may be provided in communication with processor, so as to enable near area communication of device with other devices. External interface may provide, for example, for wired communication in some implementations, or for wireless communication in other implementations, and multiple interfaces may also be used.

In a related embodiment, the architecture includes a custom fine-tuned agent configured for selecting and changing a required set of tools to execute a user specific task for rule creation, modification or deletion. The AI agents are supported by a finetuned LLM calibrated for selections and execution tasks.

In an example embodiment, the tools for executing AI agent functions include interface library-based functions configured to execute a deterministic flow of logic. For eg: Python functions could wrap multiple utilities in them such as ML model and LLM executors etc. The tools also include application programming interface (API) executors that executes API calls when requested. The system includes a set of API executors of all major API's form part of the toolbox. Further, the tools also include databases and data source connector tools. The tool includes large language model (LLM) with access to a bundle of tools to achieve the objectives. These agents are driven by prompt(s) configured to enable process orchestration and tool selection.

In an embodiment, the LLM based rule management architecture 100B includes the storage layer 114 configured to keep track of all the required data or information generated during data processing. This component of the architecture 100B, is configured for storing information such as memory objects, the selected tools, the state of execution and the error messages among others.

In an exemplary embodiment the processor 110 is a request processor configured to route user input to the rule management architecture 100B components including the AI Agents 112A, and the storage layer 114.

In an exemplary embodiment, the memory or storage layer may be a volatile, a non-volatile memory or memory may also be another form of computer-readable medium, such as a magnetic or optical disk. The memory store may also include storage device capable of providing mass storage. In one implementation, the storage device may be or contain a computer-readable medium, such as a floppy disk device, a hard disk device, an optical disk device, or a tape device, a flash memory or other similar solid-state memory device, or an array of devices, including devices in a storage area network or other configurations.

Referring to FIG. 1A, a sub-architecture 100A of a system with configurable components enabling linkedchain node implementation in enterprise application developed by codeless platform is shown in accordance with an embodiment of the invention. The architecture includes a linkedchain 129 configured to connect data attributes of the identified intent to one or more linkedchain nodes (129A, 129B, 129C) of the oner or more application functions through a linkedchain control module, where the control module is configured to enable recalibration of one or more application functions based on optimization protocols for ensuring execution of the intent. The linkedchain nodes (129A, 129B, 129C) are configured to connect the one or more operations of the enterprise application through configurable system and application components. Referring to FIGS. 1 and 1A, the rule engine or AI engine 111 identifies the impact of the rule management task on the one or more linkedchain nodes (129A, 129B, 129C) based on data pattern analysis. Also, the rule engine or AI engine 111 corelates the data attributes with the one or more linkedchain nodes (129A, 129B, 129C) for generating actionable data script created by utilizing a library of functions stored on the functional database. The system architecture 100A includes a linkedchain sync object 130 of the linkedchain nodes (129A, 129B, 129C) configured to synchronize the control module with the input. The system includes a linkedchain sync database 131 in a data lake 132 of the storage layer is configured to store a plurality of sync data for linking the dataset with the linkedchain nodes (129A, 129B, 129C).

In an advantageous aspect, the enterprise application is developed with configurable components by a platform architecture configured for codeless development of the application thereby enabling the system to reconfigure linkedchain node connections depending on the one or more operations to be executed.

In an exemplary embodiment, the linkedchain nodes (129A, 129B, 129C) are blockchain network nodes connected to one or more data blocks of the blockchain network 133. Further, in an example, a prediction of a conflict by the rule engine or the AI engine 111 triggers the block chain network nodes to identify associated operations of the application impacted by the conflict and initiating a remedial action to mitigate the risk associated with execution of the impacted nodes and operations of the enterprise application.

In another exemplary embodiment, the linkedchain nodes are non-blockchain network nodes configured to authenticate the received dataset before connecting one or more data blocks of non-blockchain network 134 to the dataset through the control module.

In an example embodiment, the system of the present invention derives relationships between functions of the enterprise application by a linkechain based application architecture 100B as shown in FIG. 1B. The operations have a commonality with the functions related to data received at the server 108. For eg: In case a transport operation executes rule modification related to transportation of an item from one point to another, the application expects the delivery of the item in an expected timeframe. However, a change in the rule needs to analyze impact of the change on associated functions and also notify the application through a system message. In such a scenario, the system of the present invention is configured to identify the linked operations that may be impacted due to this real time change. The operations linked to the transportation function such as inventory and warehouse will also be impacted due to the rule change. So, if the rule is changed, it may also distort other supply chain factors like demand planning, supply planning, inventory management, warehouse management, forecasting, cost modelling, transportation management, product life cycle management, purchase Order and sales management. Moreover, the linkedchain nodes enables implementation of the alternate rules recommendation or automatically adjusting the related operational parameters impact by the rule change.

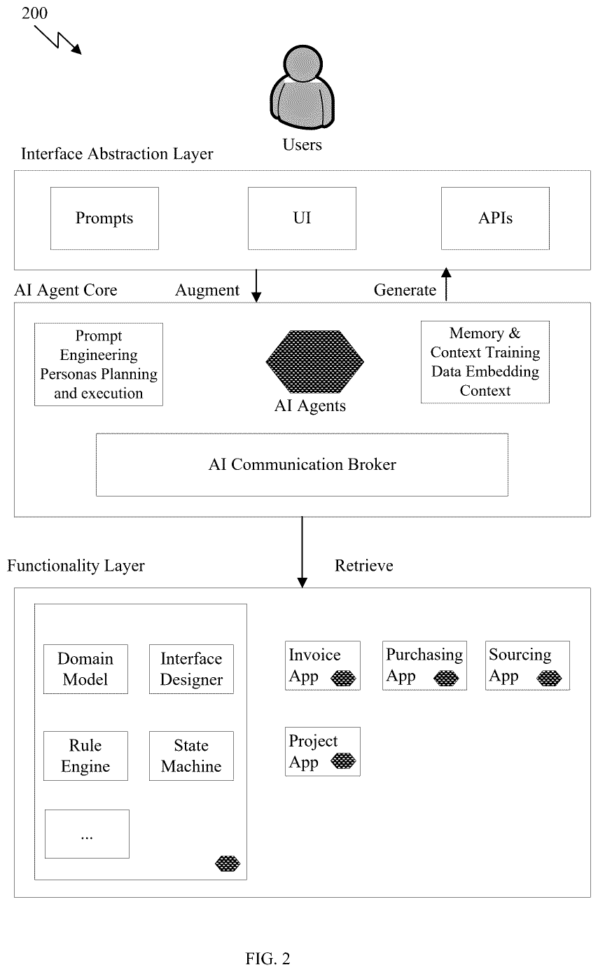

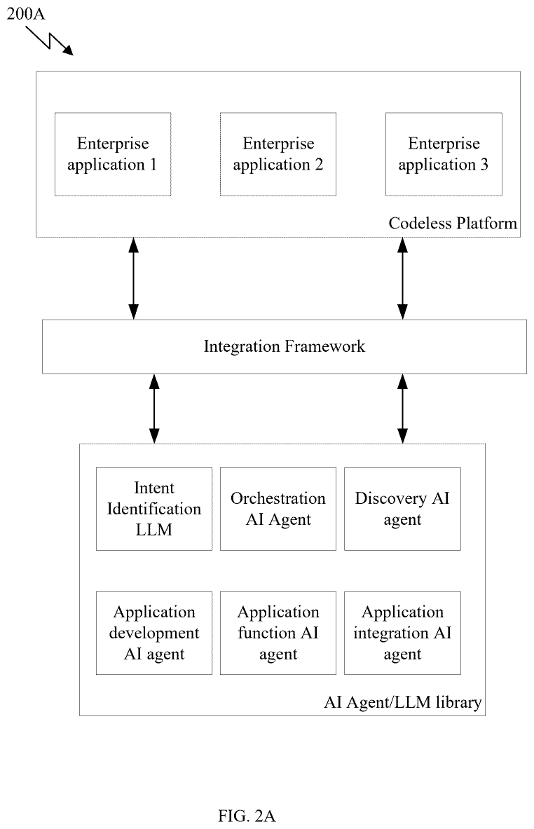

Referring to FIG. 2, an LLM based rule management Architecture 200 with RAG and CRAG is provided in an exemplary embodiment of the invention. The retrieval-Augmented Generation (RAG) architecture and Contextual Retrieval-Augmented Generation (CRAG) architecture are configured to enhance the capabilities of Large Language Models (LLMs) Agents by integrating them with external information retrieval processes. These architectures mitigate challenges faced by LLMs, such as limited domain knowledge, hallucinations, and outdated training data. For example, the RAG and CRAG address these issues, especially in enterprise applications such as procurement applications rule contexts.

The retrieval operation of the data processing method is executed based on integration of retrieval augmented Generation (RAG) and Contextual retrieval augmented Generation (CRAG) Architecture with one or more LLM agents.

The RAG combines the generative power of LLMs with a retrieval mechanism that searches a database or document set for relevant information based on the input query. This retrieved information is then used to inform and augment the model's response, making it more accurate and contextually relevant. The CRAG extends RAG by incorporating an additional layer of context into the retrieval process. This means not only finding information relevant to the query but also considering the broader context or background of the query to ensure the retrieved information is optimally relevant. In supply chain, where rule data is vast and constantly changing, RAG and CRAG revolutionize how large language models (LLMs) are applied. For instance, for contract management, these models can access and use the latest legal precedents and regulations to advise on contract creation or modification by modifying the rules running the contract management applications, thereby significantly enhancing accuracy and compliance. Integrating Retrieval-Augmented Generation (RAG) and Contextual Retrieval-Augmented Generation (CRAG) within the LLM based rule management architecture provides transformative advantages, ensuring an immersive integration that enhances accuracy, relevance, and timeliness.

In an advantageous aspect, the invention provides immersive domain Knowledge Enhancement. The integration of RAG and CRAG allows LLM Agents to access and utilize real-time, external knowledge sources, directly addressing domain knowledge limitations. This immersive approach ensures responses are augmented with the latest domain-specific data, making insights extraordinarily relevant and updated.

In another advantageous aspect, the invention provides reduction of Hallucinations Through Immersive Data Grounding. The RAG and CRAG significantly reduce the occurrence of hallucinations by grounding the rule generation process in retrieved rules containing verified information. This immersive data grounding enhances both the accuracy and credibility of the output. In rule generation for supply chain application functions, AI-generated analyses of existing rules and impact of modification of rules on applications are supported by updated, source-verified information, minimizing errors in critical rule modification processes and enhancing trust in AI-generated content.

In yet another advantageous aspect, the invention overcomes training data Cut-off with immersive real-time retrieval. The dynamic incorporation of post-training cut-off information through RAG and CRAG allows AI Agents to update their knowledge base in real time. This capability ensures that agents'outputs reflect the latest developments, particularly advantageous in fast-evolving domains like procurement.

In an embodiment, the rule management method includes contextual processing for a codeless application development task. The contextual processing includes identifying one or more complex patterns in the input, determining one or more application data objects from the complex pattern; and triggering the contextual processing of the application data objects by the at least one orchestration agent wherein the orchestration agent assigns the codeless application development task associated with the identified application object to the at least one LLM agent.

In an embodiment, augmenting the at least one LLM agent response enables contextual sentiment analysis and identification, text classification, text generation and data summarization to generate a relevant response.

In another embodiment, augmenting the at least one LLM agent includes recontextualizing the at least one LLM agent with an application context to generate the relevant data objects wherein a processor is configured to operate with memory, one or more tools, contextual awareness data script associated with the application context, one or more Artificial Intelligence (AI) agents associated with application data objects and application functions to recontextualize the at least one LLM for augmenting the at least one LLM agent.

In yet another embodiment, recontextualizing the at least one LLM agent includes converting the received input into numerical representation through embeddings; creating embeddings, one or more clusters during training and receiving sample prompts from users wherein each cluster represents a different application context; and identifying cluster nearest to an embedding representation of the received input to determine the application context, wherein a generative AI based reasoning model enables mapping of the received input to the application context in case the embedding representation is equally close to different clusters; and recontextualizing the at least one LLM agent based on the determined application context.

Referring to FIG. 2A, an architecture diagram 200A of LLM based rule management with integration framework, AI agent data library and one or more enterprise applications is provided in accordance with an embodiment of the invention.

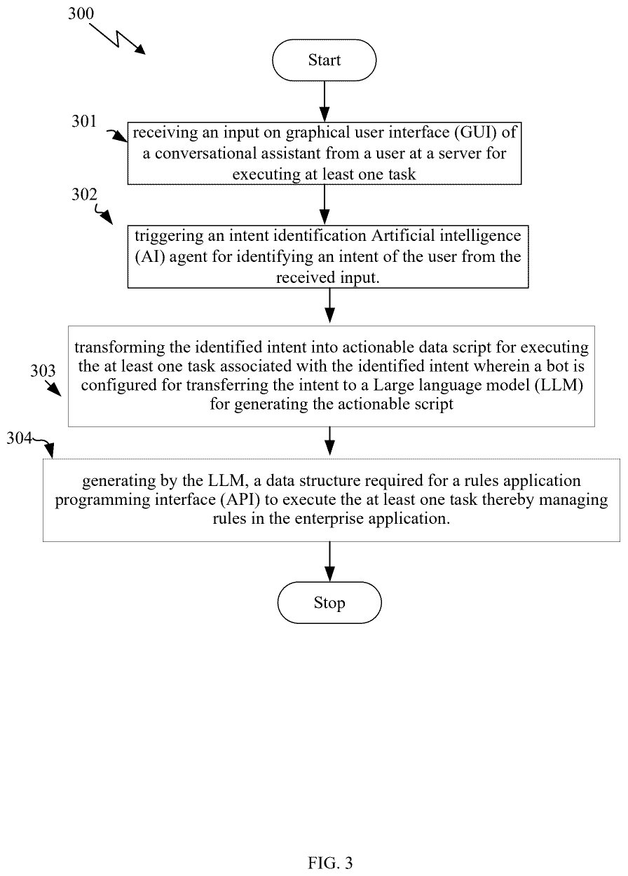

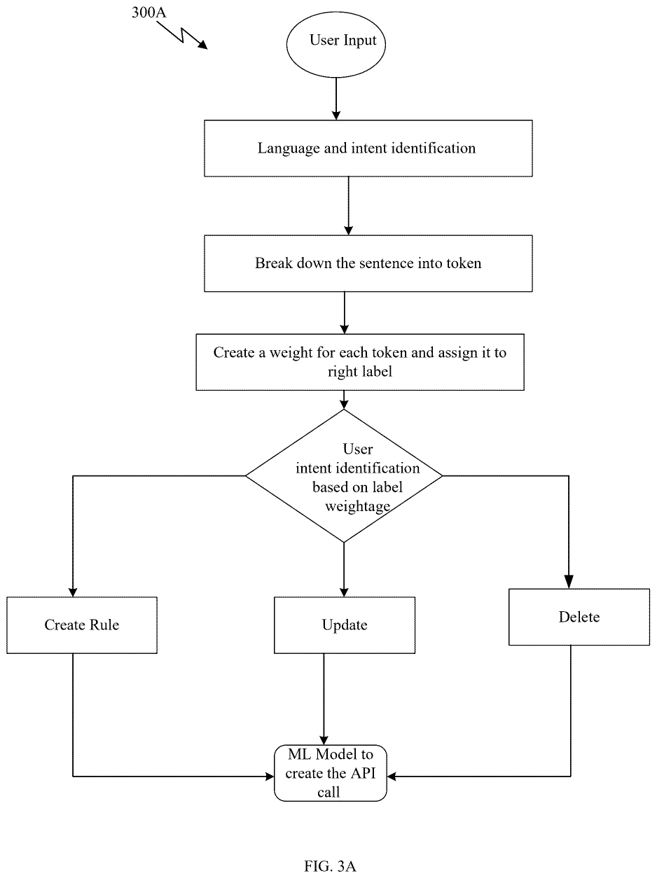

FIG. 3 is a flowchart 300 depicting a method of managing rules in an enterprise application developed by codeless platform in accordance with an embodiment of the invention. The method comprises steps of S301 receiving an input on graphical user interface (GUI) of a conversational assistant from a user at a server for executing at least one task, S302 triggering an intent identification Artificial intelligence (AI) agent for identifying an intent of the user from the received input, S303 transforming the identified intent into actionable data script for executing the at least one task associated with the identified intent wherein a bot is configured for transferring the intent to a Large language model (LLM) for generating the actionable script, and S304 generating by the LLM, a data structure required for a rules application programming interface (API) to execute the at least one task thereby managing rules in the enterprise application.

In a related embodiment, the intent includes rule creation, rule updating or modification, and rule deletion.

In another related embodiment, the method of managing rule includes a data library and a trained relational model for identification of the intent.

In an embodiment, the one or more LLM is trained by collecting, storing and pre-processing a plurality of historical data as a training data wherein the historical data is stored in a SCM historical database, cleansing the training dataset by converting the historical data, removing unwanted text from the historical data and tokenizing the training dataset into sequences of tokens that form the training dataset; and configuring a neural network based on the training dataset wherein the LLM is trained with supervised and unsupervised learning by presenting a sequence of text to the LLM for training the LLM to predict next text in the sequence wherein the LLM adjusts its weight based on a difference between its prediction and actual text.

In an embodiment, the one or more optimization protocol includes in response to determination of the intent as rule creation and the data objects indicating rule conflict, generating the one or more optimization protocol.

In an embodiment, the intent and the data objects indicating the impact enable the AI engine to predict in real time one or more adjustments required in execution of the at least one task and at least one infrastructure capacity associated with the task.

In an embodiment, the infrastructure capacity includes sizing of compute services, databases, network bandwidth, sizing of operational objects configured to execute the one or more operations.

In an embodiment, the linkedchain nodes are network nodes configured to authenticate the data attributes of the received input before connecting through the linkedchain control module.

In another embodiment, the dynamic processing logic integrates deep learning, predictive analysis, data extraction, impact analysis, configuration pattern generation and bots for processing the historical dataset to recommend the action.

In an advantageous aspect, the rule management system and method of the invention provides the capability to connect the data attributes of multiple apps within the scope of one rule application. For eg: In third party risk management (TPRM), we can create a rule that says, SupplierID=1+Budget>1000+Contract=Active.

In an example embodiment, the method of managing rule in one or more enterprise application includes the flow as a) User inputs the question or text via a chat bot (conversational assistant); b) The Chatbot will hit the LLM bot to pass on the text information; c) LLM will identify the intent of the users being create/update/delete a rule; Since, library of keywords is limited the invention utilizes relational model for keyword. d) The LLM bot sends this information over to Pre-trained Machine learning (ML) rule model; e) The ML model generates the data structure needed for the rules API; f) The ML model will hit the API to perform action; g) The Chatbot will confirm to the user on the action; and g) The rule creation identifies the impact on live transactions.

In another example embodiment, the method of rule management includes data preprocessing, modelling, and execution. In data preprocessing, a model preprocess text for a specific task to improve model performance or to turn words and characters into a format the model can understand. After data is preprocessed, it is fed into an LLM architecture that models the data to accomplish a variety of tasks. Numerical features extracted by the techniques described above can be fed into various models depending on the task at hand. For example, for classification, the output from the TF-IDF vectorizer could be provided to logistic regression, naive Bayes, decision trees, or gradient boosted trees. Or, for named entity recognition, the system uses hidden Markov models along with n-grams. Further deep neural networks typically work without using extracted features, although we can still use TF-IDF or Bag-of-Words features as input. The language model preidicts the next word when given a stream of input words. The probabilistic model that is used as one example: P(Wₙ)=P(Wₙ|Wₙ₋₁).

Deep learning is also used to create such language models. Deep-learning models take as input a word embedding and, at each time state, return the probability distribution of the next word as the probability for every word in the dictionary. Pre-trained language models learn the structure of a particular language by processing a large corpus. They can then be fine-tuned for a particular task.

In a related embodiment, the invention utilizes Naive Bayes in a supervised classification algorithm aspect that finds the conditional probability distribution P(label|text) using the following equation: P(label|text)=P(label)×P(text|label)/P(text).

This enables the LLM to predict based on which joint distribution has the highest probability. The assumption in the Naive Bayes model is that the individual words are independent. Thus: P(text|label)=P(word_1|label)*P(word_2|label)* . . . P(word_n|label).

In an exemplary embodiment, the LLM based processing enables AI based conflict resolution and recommendation while executing the rule management function. The LLM agent for intent identification and machine learning model for identification of what are the rule in our system enables execution of the rule management. As the rule is created or modified or deleted, the system is configured to detect if this will create a conflict within the system. For example, rules that show this scenario are: a) Contract value>1000 +Invoice=created THEN ContractType=Purchasing; b) Contract value>1000+Invoice=created THEN ContractType=SupplierBased. As the system identifies the contract type as two different values, it determines this rule will conflict and create a problem for the user. For determination of conflict in rule management, every action on the UI will trigger an API in real time to store in the Database, which will initiate a background process that will check the conditions for the rule and check if output matches any other rule. If so, it will throw a popup on the UI while saving the rule.

Referring to FIG. 3A a flowchart 300A depicting rule intent identification for management of rule in an enterprise application developed by codeless platform in accordance with an example embodiment of the invention. The method of intent identification for management of rule includes breaking the sentences into token, creating a weight for each token and assigning it to a right label, intent identification based on label weightage as rule creation, update or deletion through LLM and then generating API call through machine learning (ML) model.

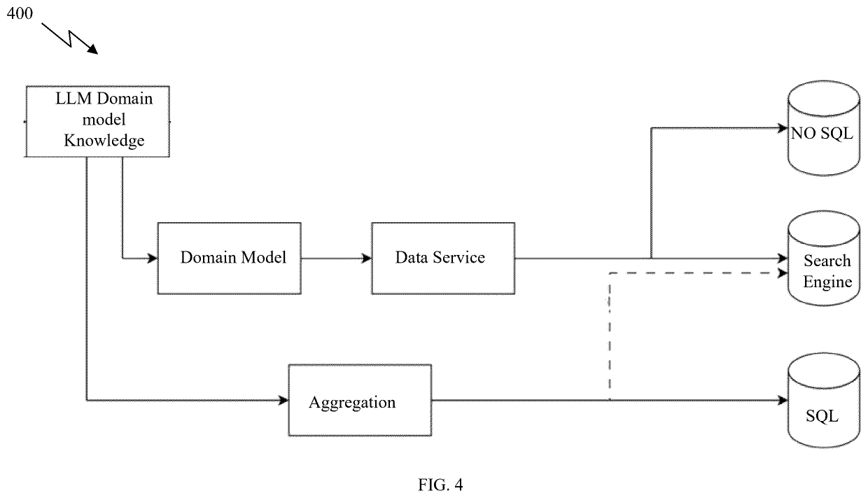

Referring to FIG. 4, a domain model LLM/AI agent functional block diagram 400 is provided in accordance with an example embodiment of the invention. The Platform-Owned Domain Model AI Agent (DM Agent) is a component designed to manage and interact with the data architecture of a low-code platform, especially within contexts like rule creation or modification in supply chain functions including Source to Pay solutions. The rule management architecture leverages the foundational structure of data models across various applications within the platform, such as invoicing, sourcing, and purchasing, to fetch, create, update, and aggregate data efficiently across diverse storage systems. The core functionalities of the LLM based architecture includes rule data management where the Domain model LLM is adept at performing CRUD (Create, Read, Update, Delete) operations across multiple data storage systems, including No SQL database for document-based data, search engine for search and quick retrieval, and a SQL Server analytics database for aggregated insights. It also includes intelligent Data Aggregation by understanding the limitations of each storage system, such as the inability to perform joins in No SQL database or the delay in data refresh in the SQL Server. The domain model LLM aggregates and synthesizes data from these sources to provide comprehensive insights. Further, the LLM based rule management provides real-time and historical data handling by seamlessly handling both real-time operational data from No SQL and search engine, and historical or aggregated data from the SQL Server, ensuring users have access to the most relevant and updated information.

In an embodiment, the operation workflow of the domain model LLM includes request analysis where upon receiving a rule modification or creation or deletion data request, the LLM analyzes the requirements to determine the exact nature of the rule needed, whether it's real-time rule modification data for operational decisions or rule creation for strategic insights. It also includes source Selection and Query Preparation where the LLM selects the appropriate source(s) based on the request's nature and prepares optimized queries for each source, considering the unique capabilities and limitations of document database and SQL Server. The LLM then executes the queries, retrieves the rules, and performs intelligent aggregation and normalization to compile a unified actionable script that meets the request's requirements. The actionable script is then formatted into a structured response, ready to be consumed by other components or LLM within the platform. Finally, the prepared rule is delivered to the requester, utilizing the platform's communication protocols, which may include direct API responses or inter-agent messaging through a Communication Broker.

In an advantageous aspect, the domain model LLM provides contextual awareness. The LLM maintains a rich contextual understanding of the domain models it manages, enabling it to make informed decisions about rule handling and application integration. It also provides Security and Compliance as given its access to potentially sensitive data across multiple applications and storage systems, the LLM is designed with robust security measures and compliance checks to protect data integrity and privacy. Further, the LLM provides performance Optimization by employing advanced algorithms and caching strategies to optimize query performance and response times, ensuring that rule interactions are both fast and efficient.

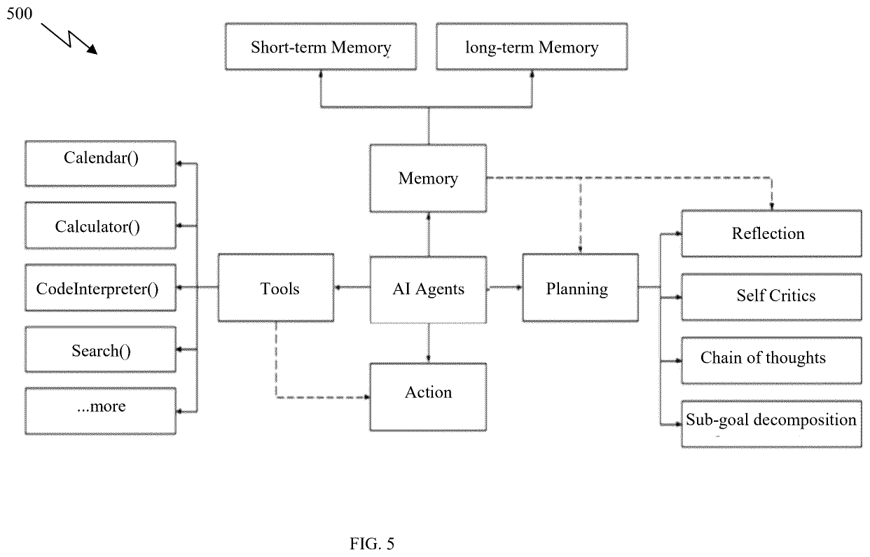

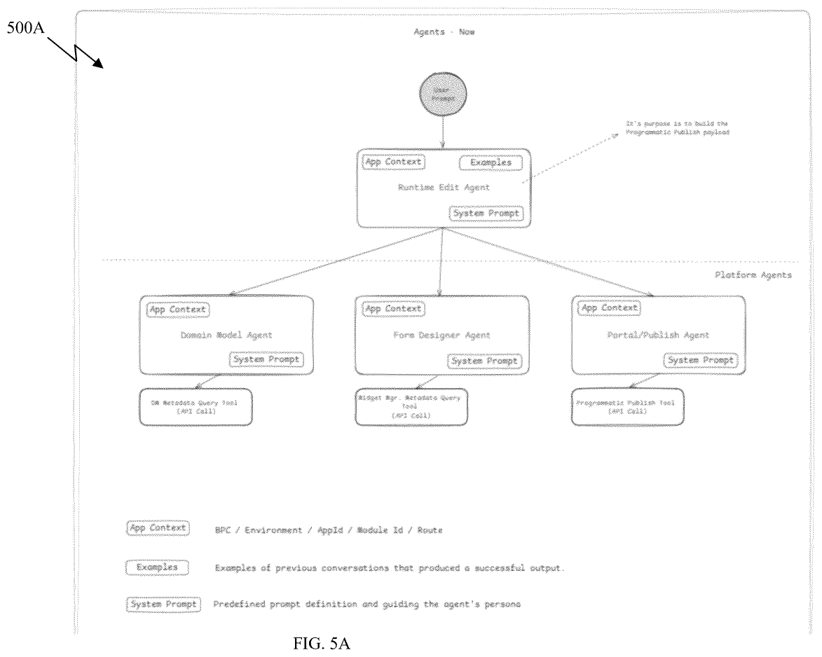

Referring to FIG. 5, a block diagram 500 depicting the guiding principle of the LLM based rule management architecture is provided in accordance with an embodiment of the invention. The one or more of the LLM has a memory to work with, it can use tools to invoke operations and/or act on things and is by default contextualized so that he knows what intents he can accommodate.

In an exemplary embodiment, the LLM comes recontextualized with the Application Context (e.g. current user, current page, current opened document, use preferences, etc.), a set of Examples of previous conversations that produced a successful output, and a collection of System Prompts which are predefined prompts definition guiding the agent's persona. The LLMs use Tools to execute actions and well-defined set of operations. These operations can take the form of an API written in a microservice or can be rule based orchestrations. The LLM is a sophisticated framework that operates with memory, tools, and contextual awareness. Its memory system allows it to store and retrieve relevant information across interactions, ensuring that it can handle complex, multi-step tasks. Contextualization ensures the LLM is aware of its environment, including the user's preferences, active documents, and prior conversations. This makes the application agents highly adaptive, capable of tailoring its responses to the current task and user needs, without manual intervention.

Referring to FIG. 5A, a design time LLM integration architecture 500A is provided in accordance with an embodiment of the invention. The trigger point of every agentic interaction is eventually a prompt which will trigger a series of conversations between the LLMs which are part of a domain. These LLLMs can be specialized upon each layer, meaning Core, Industry and Customer. The integration architecture is a zoom in for a use case where an end user wants to add a new field as part of his UI screen. To achieve this capability, there will be 3 specialized AI agents which are orchestrated by an Admin AI. The admin AI is the “Runtime Edit Agent” which is responsible for all the intents which are related to design-time changes around applications building blocks, and for each codeless platform building block needed to achieve this ask, there is an AI agent, more specifically, Domain Model Agent, Form Designer Agent and Portal/Publish agent. The domain model agent has the responsibility to define the rule for the new field as part of the data structures, using already existing API's under the form of tools, similarly Form Designer Agent has the responsibility to identify the rule for place where the new field should be added, and actually add it, and eventually, in order to see the outcome of the changes, the Portal Agent would execute the Tool to invoke the rule for the Publish API. The integration with tools is a unique feature of the AI Agent architecture. It enables the agent to execute well-defined operations through APIs or rule-based orchestrations. These tools, known as PRO Code capabilities, empower the agent to perform actions like database queries, form generation, and API calls autonomously. The modular nature of the system ensures that these tools can be extended or modified without altering the core logic.

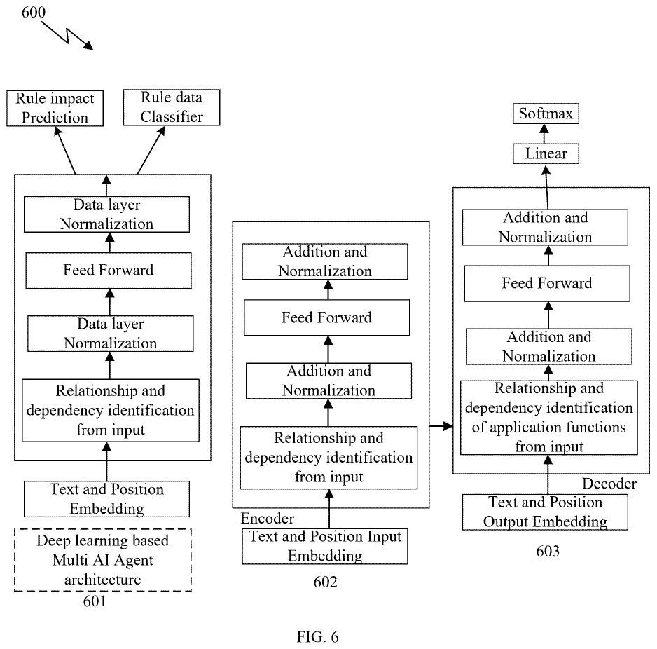

In an exemplary embodiment, the system of the invention is configured for large-scale pre-training of models on rules to modify or create supply chain and procurement domain functions and adaptation to particular SCM tasks or sub domains. However, as larger models are pre-trained, full fine-tuning, which retrains all model parameters, becomes less feasible. In an advantageous aspect, Low-Rank Adaptation (LORA), is used which freezes the pre-trained model weights and injects trainable rank decomposition matrices into each layer of the deep learning based LLM architecture 600 as shown in FIG. 6. This greatly reduces the number of trainable parameters for downstream tasks. LORA significantly reduces the number of trainable parameters and the GPU memory requirements. LORA performs better despite having fewer trainable parameters, a higher training throughput, and, unlike adapters, no additional inference latency. Further, the system facilitates integration of LORA with other models to provide efficient implementations and model checkpoints.

Referring to FIG. 6, a flow diagram 600 depicting a deep learning based rule management architecture 601 with encoder 602 and decoder 603 is provided in accordance with an example embodiment of the invention. To process a text input containing rule creation or modification request with a deep learning AI model, it is tokenized into a sequence of words. These tokens are then encoded as numbers and converted into embeddings, which are vector-space representations of the tokens that preserve their meaning. Next, the encoder in architecture transforms the embeddings of all the tokens into a context vector. The context vector allows the model to attend to different parts of an input sequence to capture its relationships and dependencies. Using the context vector, the architecture decoder generates output based on data objects of the input. For instance, the data object of the input provided by the user acts as an intent identifier and lets the decoder produce the subsequent word that naturally follows. Then, the system reuses the same decoder, but at this instance the intent identifier is the previously produced next word. This process is repeated to create an entire rule, starting from a leading code. The context vector is large so it can handle very complex concepts, and with many layers in its encoder and decoder. The LLM based on deep learning captures long-range dependencies between words, graphs elements and hence the model understands the context. Also, LLM generates rules based on previously generated tokens.

In a related aspect, for training the models including augmenting the LLM, output of the context vector is fed into a feed-forward neural network, which performs a non-linear transformation to generate a new representation. To stabilize the training process, the output from each layer is normalized, and a residual connection is added to allow the input to be passed directly to the output, allowing the model to learn which parts of the input are most important.

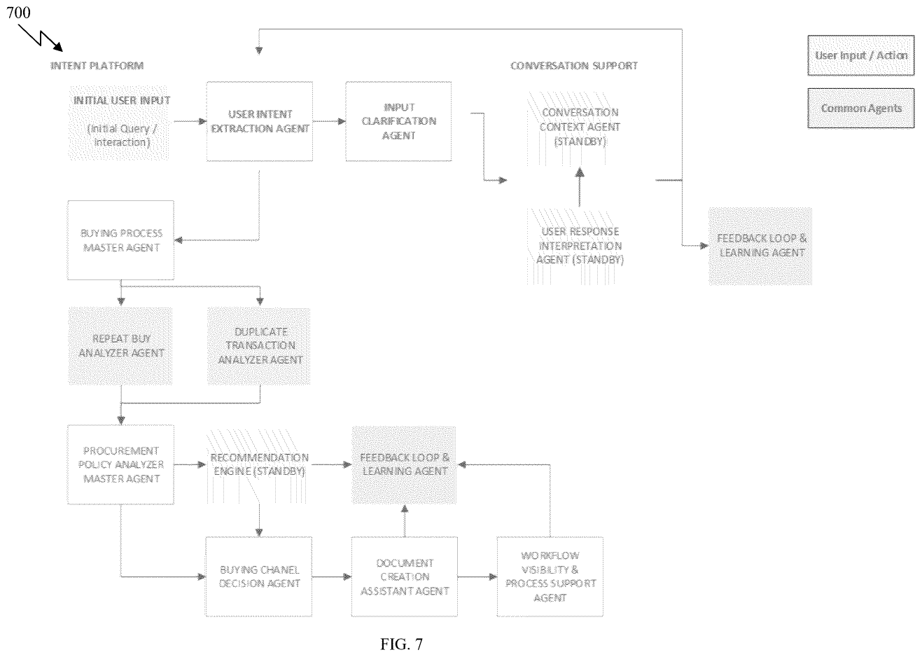

Referring to FIG. 7, the invention provides a block diagram 700 of an intent platform in accordance with an embodiment of the invention. The intent identification and extraction agent of the invention, analyzes user unput to extract key elements like users intended actions/queries and associated entities like rule category and other relevant information. The User Intent Extraction serves as the initial point of interaction between the user and the conversational AI system. Its primary function is to analyze the user's input and understand the goal from the user prompt and supporting document attached (if any) and to extract rules information. This agent ensures that the system accurately understands the user's requirements, setting the stage for subsequent actions. This includes Intent Classification to understand the user's goals, Persona/Access determination to understand functional guardrails, application function recognition for extracting specific terms relevant for the action identified, Contextual Understanding to grasp nuances in user requests, supporting documents/images based Contextual understanding, and Support for Multi-lingual prompts.

In an embodiment, the present invention provides an input clarification Agent as AI agent configured to engage with the user to clarify incomplete or ambiguous inputs by asking targeted questions, providing options and ensuring the system has all the necessary information to proceed effectively. The Input Clarification Agent plays a critical role in ensuring that the system accurately understands and processes user queries, even when they are incomplete or ambiguous. This agent is responsible for interacting with the user to gather additional details, clarifying unclear inputs, and ensuring that the system has all the necessary information to proceed effectively. Clarification Request Mechanism is a fundamental component of this agent. When the system detects that a user's input is lacking essential details or is ambiguous, the Clarification Request Mechanism kicks in. This component generates specific follow-up questions aimed at obtaining the missing information to understand the user's intent. For example, if a user asks to “create a rule for adding fields in contract management application” without specifying the type of field or clause to be incorporated with that rule, the agent might ask, “Could you please specify the type of field, and the clause where it needs to be added”. The intent clarification Agent includes a Clarification request mechanism that generates specific follow-up questions aimed at obtaining the missing information or clarifying ambiguous inputs. The intent clarification Agent also includes context-aware Dialog management to ensure that the clarification process is smooth and contextually relevant, a disambiguation module that provides options or proposals to the user to solve ambiguity, a feedback loop that collects data on how users respond to the clarification questions and whether the follow up interactions successfully resolve ambiguities, and adaptive learning algorithms for continuously learning from user interactions to improve the clarification process.

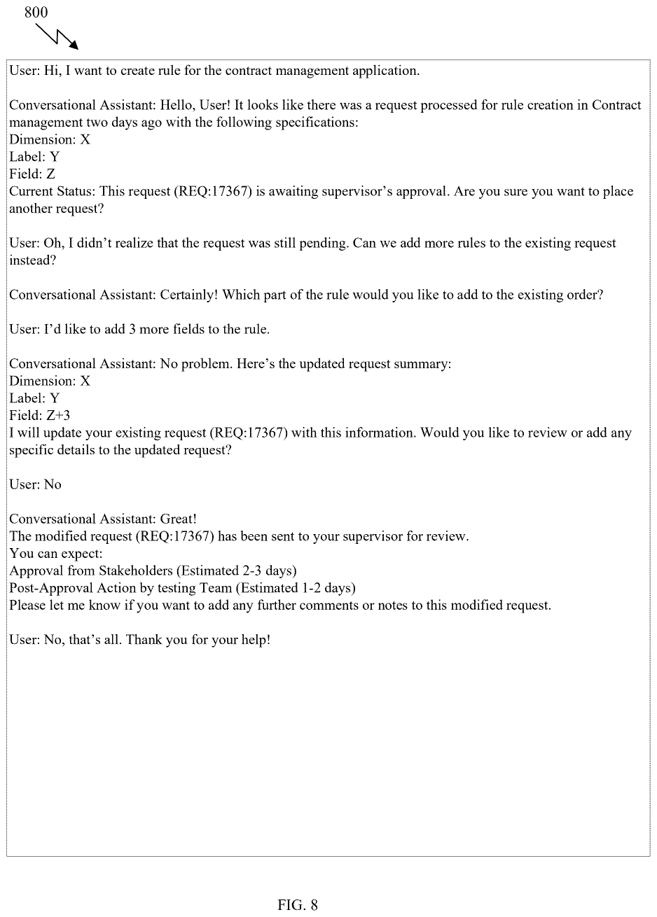

In yet another example embodiment, the AI agent of the rule management system and method includes a duplicate transaction analyzer AI agent conversational flow 800 as shown in FIG. 8. The Duplicate Transaction Analyzer Agent helps users avoid creating duplicate rules creation or modification requests by identifying similar unfulfilled requests placed in the recent past. This LLM based processing provides recommendations to users to either abort the current session or send a follow-up request on an existing request, streamlining the rule management process and reducing unnecessary duplication. One of the key components of this LLM agent is the Historical Data Analyzer, which scans the recent transaction history to identify open or unfulfilled requests that are similar to the current query. This component utilizes natural language processing and machine learning algorithms to compare the details of the current request with past transactions. For instance, if a user attempts to place a request that is nearly identical to one, they submitted a week ago and is still pending, the agent might alert the user and suggest sending a follow-up instead. The AI analyzes past requests and history to identify patterns and recurring needs, also Scans recent transaction history to identify similar open or unfulfilled requests. The AI agent includes a Similarity Detection Engine configured to compare current requests with past transactions to evaluate similarity and determine duplicate status, a Duplicate Transaction Recommendation Engine that provides recommendations and alerts to the user based on the analysis, suggesting appropriate actions. The AI agent continues with recent requests or follow up on submitted but unfulfilled requests.

In an embodiment, the present invention provides LLM based rule management system with AI based rule creation agents for Sourcing, contracting, procure to pay, supplier management, third party risk management, should cost modelling and price library management functions.

In an advantageous aspect, the rule management system converts rules from legacy systems to the requirements of the new systems. Since, LLM is trained and an augmented rule management data model on top of the LLM, triggers the solution to generate rules without requiring recreation of rules from developers. This is automatically done with the rule management system that is trained with the new systems data schema. The LLM auto-creates and ingests the data onto the destination system.

In another advantageous aspect, the system is configured to auto suggest based on scale of impact and simulation across applications. During design time of a rule, it is currently a black box on understanding what the rule will do to the current running transactions and how many documents/transactions it will impact as positive or negative. The system of the invention is configured to scan the logs and predict that any rule will impact say X number of transactions, which will help the user to understand and edit the rule as needed.

In yet another advantageous aspect, the invention enables rule management at the time of integration with other applications. The system includes connectors and recommends as the actionable script, other connects for integration.

In an exemplary embodiment, the present invention may be a system, a method, and/or a computer program product for data processing in enterprise application. The computer program product may include a computer readable storage medium (or media) having computer readable program instructions thereon for causing a processor to carry out aspects of the present invention. The media has embodied therein, for instance, computer readable program code (instructions) to provide and facilitate the capabilities of the present disclosure. The article of manufacture (computer program product) can be included as a part of a computer /stem/ computing device or as a separate product.

The computer readable storage medium can retain and store instructions for use by an instruction execution device i.e. it can be a tangible device. The computer readable storage medium may be, for example, but is not limited to, an electromagnetic storage device, an electronic storage device, an optical storage device, a semiconductor storage device, a magnetic storage device, or any suitable combination of the foregoing. A non-exhaustive list of more specific examples of the computer readable storage medium includes the following: a hard disk, a random access memory (RAM), a portable computer diskette, a read-only memory (ROM), a portable compact disc read-only memory (CD-ROM), an erasable programmable read-only memory (EPROM or Flash memory), a digital versatile disk (DVD), a static random access memory (SRAM), a floppy disk, a memory stick, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the internet, a local area network (LAN), a wide area network (WAN) and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The foregoing is considered as illustrative only of the principles of the disclosure. Further, since numerous modifications and changes will readily occur to those skilled in the art, it is not desired to limit the disclosed subject matter to the exact construction and operation shown and described, and accordingly, all suitable modifications and equivalents may be resorted to that which falls within the scope of the appended claims.

We claim

1. A data processing method for managing rules in one or more enterprise applications developed by codeless platform, the method comprising:
receiving an input on graphical user interface (GUI) of a conversational assistant from a user at a server for executing at least one task;
triggering an intent identification Artificial intelligence (AI) agent for identifying an intent of the user from the received input;
transforming the identified intent into actionable data script for executing the at least one task associated with the identified intent wherein a bot is configured for transferring the intent to a Large language model (LLM) for generating the actionable script; and
generating by the LLM, a data structure required for a rules application programming interface (API) to execute the at least one task thereby managing rules in the enterprise application.

2. The method of claim 1, wherein the step of transforming intent into actionable script includes:
mapping one or more data attributes of the identified intent with one or more application functions associated with the data attributes, wherein a linkedchain is configured to connect the data attributes to one or more linkedchain nodes of the one or more application functions through a linkedchain control module;
determining one or more data objects indicating impact of the intent on the one or more application functions; and
generating by an action bot, one or more optimization protocols for transforming the intent into actionable script,
wherein the linkedchain control module is configured to enable recalibration of one or more application functions based on the optimization protocols for ensuring execution of the intent.

3. The method of claim 2, wherein the intent includes rule creation, rule updating, and rule deletion.

4. The method of claim 3, further comprises a data library and a trained relational model for identification of the intent.

5. The method of claim 1, wherein the applications include a supply chain management application and the at least one task includes a rule management task including rule creation, rule modification or rule deletion task associated with a supply chain management application task such as contract management, Purchase order, invoice management, Spend analysis, Sourcing, inventory management, demand planning, quality management, supply planning, should cost modeling, transportation management, warehouse management, forecasting, vendor management, risk assessment management and project management.

6. The method of claim 2, wherein the one or more LLM is trained by:
collecting, storing and pre-processing a plurality of historical data as a training data wherein the historical data is stored in a SCM historical database;
cleansing the training dataset by converting the historical data, removing unwanted text from the historical data and tokenizing the training dataset into sequences of tokens that form the training dataset; and
configuring a neural network based on the training dataset wherein the LLM is trained with supervised and unsupervised learning by presenting a sequence of text to the LLM for training the LLM to predict next text in the sequence wherein the LLM adjusts its weight based on a difference between its prediction and actual text.

7. The method of claim 2, wherein the one or more optimization protocol includes:
in response to determination of the intent as rule creation and the data objects indicating rule conflict, generating the one or more optimization protocol.

8. The method of claim 2, further comprises:
in response to identification of the intent and determination of the task as a rule migration task, triggering the LLM configured for mapping data schema of a first enterprise application with requirements of a second enterprise application, wherein the bot is configured for auto creating and ingesting data of the first enterprise application onto the second enterprise application by the linkedchain control module.

9. The method of claim 2, wherein the linked-chain nodes connect to the one or more application functions through configurable components of the enterprise application wherein an AI engine correlates the data attributes with the one or more linked-chain nodes for generating the actionable data script created by utilizing a library of functions stored on a functional database.

10. The method of claim 9, wherein the intent and the data objects indicating the impact enable the AI engine to predict in real time one or more adjustments required in execution of the at least one task and at least one infrastructure capacity associated with the task.

11. The method of claim 10, wherein the infrastructure capacity includes sizing of compute services, databases, network bandwidth, sizing of operational objects configured to execute the one or more operations.

12. The method of claim 11, wherein the linkedchain nodes are network nodes configured to authenticate the data attributes of the received input before connecting through the linkedchain control module.

13. The method of claim 12, further comprises:
processing the historical data to predict the impact of the input on the one or more application functions and generating an actionable script for execution of the at least one task based on a dynamic processing logic.

14. The method of claim 13, wherein the dynamic processing logic integrates deep learning, predictive analysis, data extraction, impact analysis, configuration pattern generation and bots for processing the historical dataset to recommend the action.

15. The method of claim 14, wherein the at least one task includes creating rule for embedding templates to restructure the application wherein the templates are related to sourcing, procurement or supply chain functions.

16. The method of claim 15, wherein the at least one task includes modification of an existing rule to alter UI component on the application for accommodating transformations required based on new operational requirement for the application.

17. The method of claim 16, wherein the at least one task includes injecting rules for configuring labels in multi languages of form elements and publish the labels on the application to start leveraging operational forms including Purchase Order, Contract and Inventory.

18. The method of claim 2, wherein a code of the one or more protocols configured for transforming the intent into actionable script enables identification of the linkedchain node associated with the one or more application functions.

19. A data processing system for managing rules in one or more enterprise applications developed by a codeless platform, the system comprising:
at least one processor and a memory storing instructions that allow the at least one processor to
receive an input on GUI of a conversational assistant from a user at a server for executing at least one task;
trigger an intent identification AI agent for identifying an intent of the user from the received input;
transform the identified intent into actionable data script for executing the at least one task associated with the identified intent wherein a bot is configured for transferring the intent to an LLM model for generating the actionable script; and
generate by the LLM model, a data structure required for a rules API to execute the at least one task thereby managing rules in the enterprise application.

20. The system of claim 19, wherein the processor is configured to transform intent into actionable script by:
mapping one or more data attributes of the identified intent with one or more application functions associated with the data attributes, wherein a linkedchain is configured to connect the data attributes to one or more linkedchain nodes of the one or more application functions through a linkedchain control module;
determining one or more data objects indicating impact of the intent on the one or more application functions; and
generating by an action bot, one or more optimization protocols for transforming the intent into actionable script,
wherein the linkedchain control module is configured to enable recalibration of one or more application functions based on the optimization protocols for ensuring execution of the intent.

21. The system of claim 20, wherein the intent includes rule creation, rule updating, and rule deletion.

22. The system of claim 19, wherein the applications include a supply chain management application and the at least one task includes a rule management task associated with a supply chain management application task such as contract management, Purchase order, invoice management, Spend analysis, Sourcing, inventory management, demand planning, quality management, supply planning, should cost modeling, transportation management, warehouse management, forecasting, vendor management, risk assessment management and project management.

23. The system of claim 20, wherein the one or more LLM is trained by:
collecting, storing and pre-processing a plurality of historical data as a training data wherein the historical data is stored in a SCM historical database;
cleansing the training dataset by converting the historical data, removing unwanted text from the historical data and tokenizing the training dataset into sequences of tokens that form the training dataset; and
configuring a neural network based on the training dataset wherein the LLM is trained with supervised and unsupervised learning by presenting a sequence of text to the LLM for training the LLM to predict next text in the sequence wherein the LLM adjusts its weight based on a difference between its prediction and actual text.

24. The system of claim 20, wherein the one or more optimization protocol includes:
in response to determination of the intent as rule creation and the data objects indicating rule conflict, generating the one or more optimization protocol.

25. The system of claim 20, further comprises:
in response to identification of the intent and determination of the task as a rule migration task, triggering the LLM configured for mapping data schema of a first enterprise application with requirements of a second enterprise application, wherein the bot is configured for auto creating and ingesting data of the first enterprise application onto the second enterprise application by the linkedchain control module.

26. The system of claim 20, wherein the linked-chain nodes connect to the one or more application functions through configurable components of the enterprise application wherein an AI engine correlates the data attributes with the one or more linked-chain nodes for generating the actionable data script created by utilizing a library of functions stored on a functional database.

27. The system of claim 25, wherein the intent and the data objects indicating the impact enable the AI engine to predict in real time one or more adjustments required in execution of the at least one task and at least one infrastructure capacity associated with the task.

28. The system of claim 27, wherein the infrastructure capacity includes sizing of compute services, databases, network bandwidth, sizing of operational objects configured to execute the one or more operations.

29. The system of claim 25, wherein the linkedchain nodes are network nodes configured to authenticate the data attributes of the received input before connecting through the linkedchain control module.

30. The system of claim 29, wherein the at least one processor is configured for
processing the historical data to predict the impact of the input on the one or more application functions and generating an actionable script for execution of the at least one task based on a dynamic processing logic.

31. The system of claim 30, wherein the dynamic processing logic integrates deep learning, predictive analysis, data extraction, impact analysis, configuration pattern generation and bots for processing the historical dataset to recommend the action.

32. The system of claim 31, wherein the at least one task includes creating rule for embedding templates to restructure the application wherein the templates are related to sourcing, procurement or supply chain functions.

33. The system of claim 32, wherein the at least one task includes modification of an existing rule to alter UI component on the application for accommodating transformations required based on new operational requirement for the application.

34. The system of claim 33, wherein the at least one task includes injecting rules for configuring labels in multi languages of form elements and publish the labels on the application to start leveraging operational forms including Purchase Order, Contract and inventory.

35. The system of claim 20, wherein a code of the one or more protocols configured for transforming the intent into actionable script enables identification of the linkedchain node associated with the one or more application functions.

36. The system of claim 19, wherein the codeless platform is configured to enable the at least one processor for codeless application development, the codeless platform includes:
a customization layer; an application layer; a shared framework layer; a foundation layer; a data layer; and an application orchestrator; wherein the one or more processors is configured to cause the plurality of configurable components to interact with each other in a layered architecture to:
customize the one or more application based on at least one operation to be executed using the customization layer;
organize at least one application service of the one or more application by causing the application layer to interact with the customization layer through one or more configurable components of the plurality of configurable components, wherein the application layer is configured to organize the at least one application service of the one or more application;
fetch shared data objects to enable execution of the at least one application service by causing the shared framework layer to communicate with the application layer through one or more configurable components of the plurality of configurable components, wherein the shared framework layer is configured to fetch the shared data objects to enable execution of the at least one application service, wherein fetching of the shared data objects is enabled via the foundation layer communicating with the shared framework layer, wherein the foundation layer is configured for infrastructure development through the one or more configurable components of the plurality of configurable components;
manage database native queries mapped to that at least one operation using a data layer to communicate with the foundation layer through one or more configurable components of the plurality of configurable components, wherein the data layer is configured to manage database native queries mapped to the at least one operation; and
execute the at least one operation and develop the one or more application using the application orchestrator to enable interaction of the plurality of configurable components in the layered architecture.

37. A non-transitory computer program product for managing rules in one or more enterprise applications of a computing device with memory, the product comprising:
a computer readable storage medium readable by a processor and storing instructions for execution by the processor for performing a method, the method comprising:
receiving an input on GUI of a conversational assistant from a user at a server for executing at least one task;
triggering an intent identification AI agent for identifying an intent of the user from the received input;
transforming the identified intent into actionable data script for executing the at least one task associated with the identified intent wherein a bot is configured for transferring the intent to an LLM model for generating the actionable script; and
generating by the LLM model, a data structure required for a rules API to execute the at least one task thereby managing rules in the enterprise application.

38. The non-transitory computer program product of claim 37, wherein the method is performed in a cloud or cloud-based computing environment.
